(19) United States
(12) Patent Application Publication
(10) Pub. No.: US 2007/0067153 A1
(43) Pub. Date: Mar. 22, 2007

(54) Morphological analysis apparatus, morphological analysis method and morphological analysis program

(75) Inventor: Tetsuji Nakagawa, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/522,906

(22) Filed: Sep. 19, 2006

(30) Foreign Application Priority Data
Sep. 21, 2005 (JP) 2005-274483

(51) Int. Cl. G06F 17/28

(52) U.S. Cl. 704/4

(57) ABSTRACT

The morphological analysis apparatus according to the present invention, comprises a spelling recovery unit that recovers the spellings of words, a morphological analysis candidate generation unit that segments a word sequence composed of words, the spellings of which have been recovered, into morphemes, appends POS tags to the morphemes and generates a single morphological analysis candidate or a plurality of morphological analysis candidates, a generation probability calculation unit that calculates a generation probability for each morphological analysis candidate having been generated based upon the product of the probability of the pre-spelling recovery word being converted to the post-spelling recovery word and the probability of a morpheme sequence and a POS sequence being generated from the post-spelling recovery word sequence and a solution search unit that selects through a search the most likely candidate as a solution from all the morphological analysis candidates for which the generation probabilities have been calculated by the generation probability calculation unit.

### CROSS REFERENCE TO RELATED APPLICATION

The disclosure of Japanese Patent Application No. JP 2005-274483, filed Sep. 21, 2005 entitled “Morphological Analysis Apparatus, Morphological Analysis Method and Morphological Analysis Program”. The contents of that application are incorporated herein by reference in their entirety.

### BACKGROUND OF THE INVENTION

The present invention relates to a morphological analysis apparatus, a morphological analysis method and a morphological analysis program, which may be adopted in a morphological analysis system that executes machine translation from a source language, e.g., Korean.

### DESCRIPTION OF THE RELATED ART

Morphological analysis, whereby morphemes and their related parts of speech (POS) are identified in an input sentence, is essential processing that must be executed in a machine translation system and the results of the morphological analysis greatly affect the accuracy of the subsequent processing. For this reason, a morphological analysis apparatus must be capable of outputting highly accurate solutions optimized for the target language.

While Korean is often considered to be linguistically similar to Japanese, the Korean language has several unique characteristics. For instance, unlike Japanese, written Korean employs spaces between each word. In addition, Korean words are often contracted and the word forms change in an extremely complex manner. These characteristics must be fully addressed in morphological analysis of the Korean language. “Language System and Morphological Processing Technique for Korean Computational Processing”; Journal of Natural Language Processing, vol 7, No. 4, October 2000 (nonpatent reference literature 1), authored by Kazuhide Yamamoto, discloses a method for Korean morphological analysis. In the method disclosed in this publication, morphological analysis is executed by using a dictionary prepared based upon a “residual character” concept and containing additional information indicating the corresponding residual character for each contractible morpheme. If residual character information is attached to a morpheme in the dictionary, the character sequence corresponding to the residual characters can also be looked up in the dictionary, i.e., a morpheme of a word, the form of which has been altered through contraction, can be looked up in the dictionary.

In addition, “A Morphological Tagger for Korean: Statistical Tagging Combined With Corpus-Based Morphological Rule Application” Machine Translation, vol 18, No. 4, December 2004 (nonpatent reference literature 2), authored by Chung-Hye Han and Martha Palmer, also discloses a method of Korean morphological analysis. In the method, spelling recovery is first executed, POS are tagged and finally, the individual morphemes are identified. Through the spelling recovery processing, the spelling of each morpheme that may have been altered through contraction or the like, is first recovered to the original form for subsequent processing. In addition, a dictionary, parameters and the like can all be obtained by learning from a training corpus.

However, the following problems may occur in the morphological analysis methods in the related art described above.

For instance, the method disclosed in nonpatent reference literature 1 requires a great deal of human labor or the like in order to create in advance a morphological dictionary containing the additional residual character information. In other words, the morphological dictionary needs to be prepared through an onerous process. In addition, nonpatent reference literature 1 does not describe any measures that may be taken when dealing with an unknown word not included in the morphological dictionary, and thus, unknown words cannot be processed through the method disclosed in nonpatent reference literature 1.

While a dictionary and the like can be automatically created based upon the corpus and unknown words can be processed through the method disclosed in nonpatent reference literature 2, the method requires that the spelling recovery processing and the POS tagging processing be executed independently of each other and does not search for the optimal solution through the overall morphological analysis processing. Furthermore, since the solution is determined based upon a simple rule when identifying each morpheme, the processing results may remain ambiguous if there are a plurality of solution candidates.

### SUMMARY OF THE INVENTION

As described above, there is a great need for a morphological analysis apparatus, a morphological analysis method and a morphological analysis program, which enable morphological analysis of a sentence containing both known words and unknown words, enable an accurate search of an optimal solution through the whole morphological analysis and make it possible to prepare a morphological dictionary with efficiency.

The need described above is satisfied in the morphological analysis apparatus achieved in a first aspect of the present invention, comprising (1) a spelling recovery unit that converts the spellings of words in an input sentence based upon a predetermined spelling recovery rule, (2) a morphological analysis candidate generation unit that segments each word in the sentence , the spellings of which have been recovered by the spelling recovery unit, into morphemes, appends POS tags to the morphemes and generates a single morphological analysis candidate or a plurality of morphological analysis candidates, (3) a generation probability calculation unit that calculates a generation probability for each morphological analysis candidate having been generated based upon the product of the probability of the pre-spelling recovery word being converted to the post-spelling recovery word and the probability of a morpheme sequence and a POS sequence being generated from the post-spelling recovery word sequence and (4) a solution search unit that selects through a search the most likely candidate as a solution from all the morphological analysis candidates for which the generation probabilities have been calculated by the generation probability calculation unit.

The morphological analysis method achieved in a second aspect of the present invention comprises (1) a spelling recovery step in which the spellings of words in an input sentence is converted based upon a specific spelling recovery rule, (2) a morphological analysis candidate generation step in which each word in the sentence whose spelling thereof having been recovered through the spelling recovery step is segmented into morphemes with POS tags attached to them and a single morphological analysis candidate or a plurality of morphological analysis candidates are generated, (3) a generation probability calculation step in which a generation probability is calculated for each morphological analysis candidate having been generated, based upon the product of the probability of the pre-spelling recovery word being converted to the post-spelling recovery word and a probability of a morpheme sequence and a POS sequence being generated from the post-spelling recovery word sequence and (4) a solution search step in which the most likely candidate is selected through a search as a solution from the morphological analysis candidates for which the generation probabilities have been calculated through the generation probability calculation step.

The morphological analysis program achieved in a third aspect of the present invention enables a computer to function as (1) a spelling recovery unit that converts the spellings of words in an input sentence based upon a predetermined spelling recovery rule, (2) a morphological analysis candidate generation unit that segments each word in the sentence, the spellings of which have been recovered by the spelling recovery unit, into morphemes, appends POS tags to the morphemes and generates a single morphological analysis candidate or a plurality of morphological analysis candidates, (3) a generation probability calculation unit that calculates a generation probability for each morphological analysis candidate having been generated based upon the product of the probability of the pre-spelling recovery word being converted to the post-spelling recovery word and the probability of a morpheme sequence and a POS sequence being generated from the post-spelling recovery word sequence and (4) a solution search unit that selects through a search the most likely candidate as a solution from all the morphological analysis candidates for which the generation probabilities have been calculated by the generation probability calculation unit.

The morphological analysis apparatus, the morphological analysis method and the morphological analysis program according to the present invention enable morphological analysis of a sentence containing both known words and unknown words, enable accurate search of an optimal solution through the whole morphological analysis or allow a morphological dictionary to be prepared efficiently.

### THE BRIEF DESCRIPTION OF THE DRAWINGS

FIG. 1 is a functional block diagram showing the structure adopted in the morphological analysis system in a first embodiment;

FIG. 2 presents a flowchart of the operations executed during the morphological analysis processing in the first embodiment;

FIG. 3 presents a flowchart of the processing executed in the first embodiment to segment a target sentence into-morphemes and generate POS-tag hypotheses;

FIG. 4 presents a flowchart executed in the first embodiment to prepare a dictionary and generate parameters to be used in the morphological analysis system;

FIG. 5 presents a flowchart of an example of processing that may be executed in the first embodiment to prepare spelling recovery rules;

FIG. 6 shows an example of spelling recovery rules that may be prepared in the first embodiment;

FIG. 7 shows an example of a morphological dictionary that may be prepared in the first embodiment;

FIG. 8 presents an example of a morphologically analyzed corpus that may be prepared in the first embodiment;

FIG. 9 shows various hypotheses that may be drawn for an input sentence in the first embodiment;

FIG. 10 shows various hypotheses that may be drawn for an input sentence in the first embodiment; and

FIG. 11 shows various hypotheses that may be drawn for an input sentence in the first embodiment.

### DETAILED DESCRIPTION OF THE PREFERRED EMBODIMENT

### (A) First Embodiment

The following is a detailed explanation of the morphological analysis apparatus, the morphological analysis method and the morphological analysis program achieved in an embodiment of the present invention, given in reference to the drawings.

In the embodiment, the morphological analysis apparatus, the morphological analysis method and the morphological analysis program according to the present invention are adopted in a Korean morphological analysis system.

(A-1) Structure Adopted in the First Embodiment

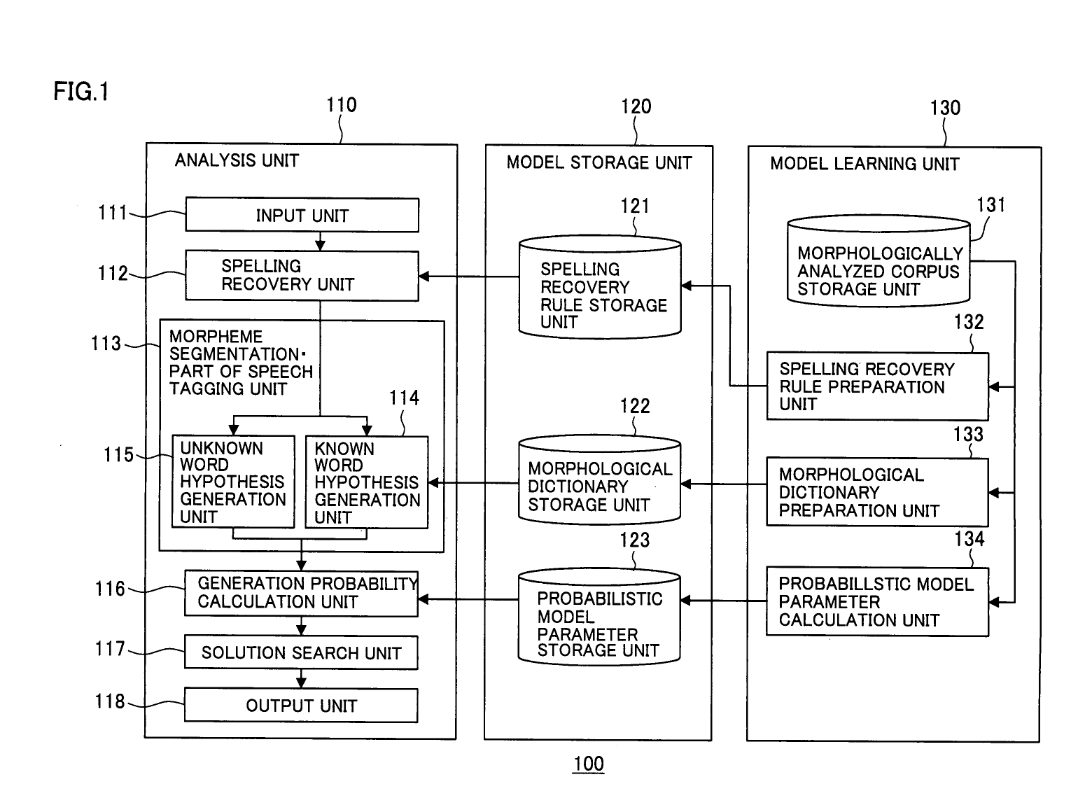

FIG. 1 is a functional block diagram showing the structure adopted in the morphological analysis system in the embodiment. It is to be noted that the morphological analysis system 100 is realized in an information processing apparatus in the embodiment, by, for instance, executing a processing program related to morphological analysis, which may be stored in a hard disk or a specific recording medium, via the CPU of the information processing apparatus.

As shown in FIG. 1, the morphological analysis system 100 achieved in the embodiment comprises at least an analysis unit 110 that executes morphological analysis processing, a model storage unit 120 in which spelling recovery rules, a morphological dictionary and probabilistic model parameters to be used during the morphological analysis processing are stored, and a model learning unit 130 that learns the parameters and the like from a corpus having undergone morphological analysis.

As shown in FIG. 1, the analysis unit 110 includes at least an input unit 111, a spelling recovery unit 112, a morpheme segmentation·POS tagging unit 113, a generation probability calculation unit 116, a solution search unit 117 and an output unit 118. In addition, the morpheme segmentation·POS tagging unit 113 includes a known word hypothesis generation unit 114 and an unknown word hypothesis generation unit 115.

The input unit 111 takes in an input sentence entered by the user and provides the input sentence to the spelling recovery unit 112. The input unit 111 may take in the information entered by the user through, for instance, a keyboard.

The spelling recovery unit 112 receives the input sentence having been taken in via the input unit 111, recovers a word in the input sentence, if the spelling of which has been altered, into the original form based upon a spelling recovery rule stored in a spelling recovery rule storage unit 121 and prepares a single candidate or a plurality of candidates (hereafter, such a candidate is referred to as an “hypothesis”). As a result, even if the word form has been altered through, for instance, contraction, the altered word can be replaced with a word form assumed to represent the initial spelling. In addition, the spelling recovery unit 112 provides each hypothesis representing the recovered spelling to the morpheme segmentation·POS tagging unit 113.

The morpheme segmentation·POS tagging unit 113 receives the candidates (hypotheses) representing spellings having been recovered by the spelling recovery unit 112 for the word and prepares new hypotheses each in correspondence to one of the hypotheses with the recovered spellings by dividing each hypothesis into morphemes and appending POS tags based upon the morphological dictionary stored in a morphological dictionary storage unit 122. In addition, the morpheme segmentation·POS tagging unit 113 provides the new hypotheses having undergone the morpheme segmentation and the POS tagging to the generation probability calculation unit 116.

The generation probability calculation unit 116 calculates a generation probability for each hypothesis having been prepared by the morpheme segmentation·POS tagging unit 113, based upon the parameters stored in a probabilistic model parameter storage unit 123.

The solution search unit 117 selects as a solution the most likely hypothesis among the hypotheses for which the generation probabilities have been calculated by the generation probability calculation unit 116.

The output unit 118 outputs the solution selected by the solution search unit 117.

The model storage unit 120 includes at least the spelling recovery rule storage unit 121, the morphological dictionary storage unit 122 and the probabilistic model parameter storage unit 123.

In the spelling recovery rule storage unit 121, a plurality of spelling recovery rules to be used during the spelling recovery processing are stored. The spelling recovery rules stored in the spelling recovery rule storage unit 121 are prepared by a spelling recovery rule preparation unit 132.

In the morphological dictionary storage unit 122, a morphological dictionary listing morphemes and the POS categories to which the individual morphemes belong is stored. Each pair of a morpheme and a POS category listed in the morphological dictionary stored in the morphological dictionary storage unit 122 is prepared at a morphological dictionary preparation unit 133.

In the probabilistic model parameter storage unit 123, probabilistic model parameters are stored. The probabilistic model parameters stored in the probabilistic model parameter storage unit 123 are prepared by a probabilistic model parameter calculation unit 134.

The model learning unit 130 includes at least a morphologically analyzed corpus storage unit 131, the spelling recovery rule preparation unit 132, the morphological dictionary preparation unit 133 and the probabilistic model parameter calculation unit 134.

In the morphologically analyzed corpus storage unit 131, a corpus having undergone morphological analysis is stored.

The spelling recovery rule preparation unit 132 prepares rules to be applied during the spelling recovery processing by using the corpus stored in the morphologically analyzed corpus storage unit 131 and provides the spelling recovery rules thus prepared to the spelling recovery rule storage unit 121.

The morphological dictionary preparation unit 133 prepares the morphological dictionary by using the corpus stored in the morphologically analyzed corpus storage unit 131 and provides the prepared morphological dictionary to the morphological dictionary storage unit 122.

The probabilistic model parameter calculation unit 134 calculates probabilistic model parameters by using the corpus stored in the morphologically analyzed corpus storage unit 131 and provides the calculation results to the probabilistic model parameter storage unit 123.

(A-2) Operations Executed in the First Embodiment

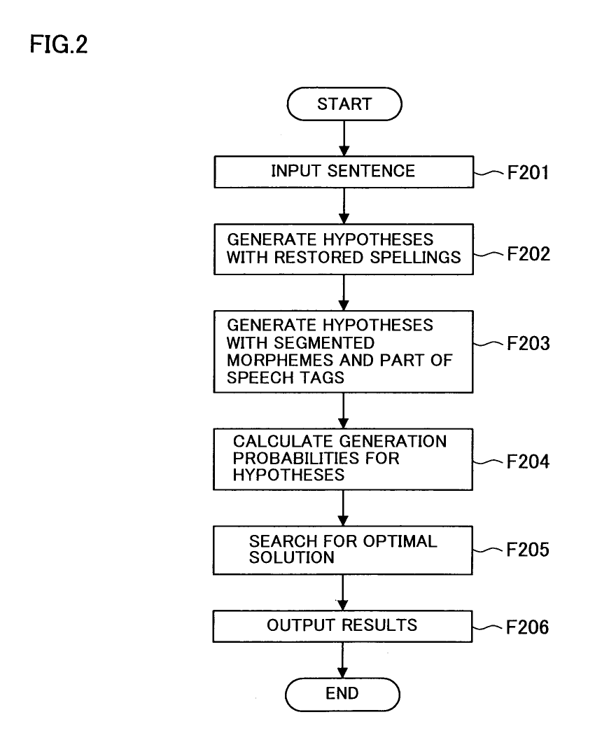

The following is an explanation of the operations executed during the morphological analysis processing in the morphological analysis system 100 in the embodiment, given in reference to drawings. FIG. 2 presents a flowchart of the operations executed during the morphological analysis processing in the embodiment.

An input sentence entered by the user is first taken into the input unit 111 and the input sentence is then provided to the spelling recovery unit 112 (F201).

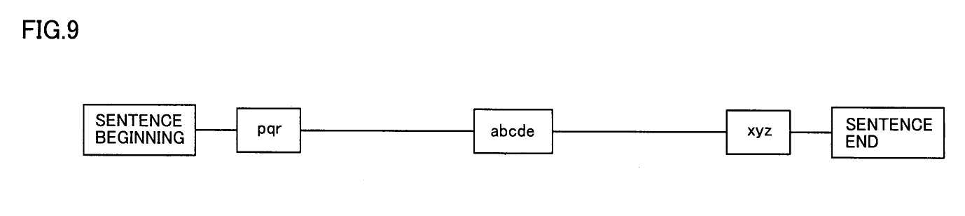

Let us assume that the sentence entered by the user for the morphological analysis is “pqr abcde xyz”. It is to be noted that Roman characters are used in place of Korean (Hangul) characters in this example. The hypotheses (analysis candidates) obtained through the morphological analysis can be represented in a graph and the hypotheses derived from the input sentence “pqr abcde xyz” having been entered may be as shown in FIG. 9.

Upon receiving the input sentence having been taken in through the input unit 111, the spelling recovery unit 112 recovers the spelling of words in the input sentence that have had their word forms altered, based upon the spelling recovery rules stored in the spelling recovery rule storage unit 121, and generates hypotheses each representing a recovered spelling (F202).

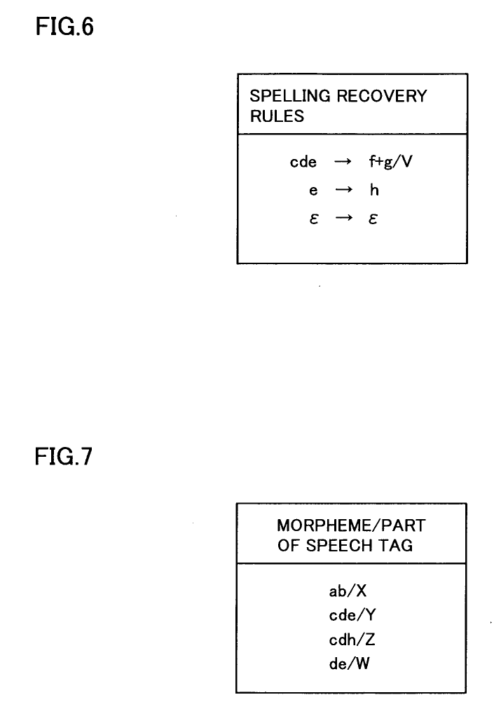

For instance, spelling recovery rules such as those shown in FIG. 6 may be stored in the spelling recovery rule storage unit 121. The term “spelling recovery rule” is used in this context to refer to a rule in conformance to which the spelling of a word that has been outwardly altered due to contraction, a notational change or a word form change is recovered to the original spelling.

It is to be noted that a spelling recovery rule is applied to a character sequence at the end of a given word.

For instance, in the spelling recovery rules (X->Y) shown in FIG. 6, “X” represents a pre-spelling recovery character sequence and “Y” represents the post-spelling recovery character sequence. According to these rules, the character sequence “X” at the end of the word is replaced with the character sequence “Y”.

More specifically, a character sequence “e” at the end of a word is replaced with a character sequence “h” based upon the spelling recovery rule “e->h” in FIG. 6.

However, “ε” in FIG. 6 is a special symbol indicating a empty character sequence, and the spelling recovery rule “ε->ε” represents a special rule whereby a empty character sequence is converted to a empty character sequence, i.e., whereby the character sequence is not converted.

In addition, the spelling recovery rule “cde->f+g/V” indicates that a character sequence “cde” is converted to a character sequence “fg” through the spelling recovery, and also includes a constraint that the morpheme “g” is tagged with a POS “V”. It is to be noted that the symbol “+” is a morpheme boundary mark separating the morpheme with a POS category from another, and the POS category of a particular morpheme is indicated after the symbol “/”. As a result, the morpheme boundary points in the character sequence and the POS category of a specific morpheme can be indicated based upon the spelling recovery rules if necessary.

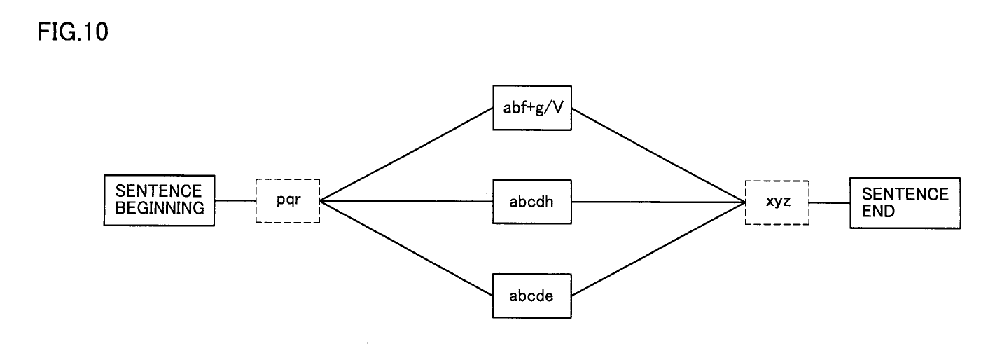

An explanation is now provided by focusing on the word “abcde” in the input sentence “pqr abcde xyz” that has been provided to the spelling recovery unit 112. As the spelling recovery rules in FIG. 6 include the spelling recovery rule “cde->f+g/V”, the spelling recovery rule “e->h” and the spelling recovery rule “ε->ε”, the word “abcde” in the input sentence is converted to character sequences “abf+g/V”, “abcdh” and ” abcde” in conformance to the individual rules. FIG. 10 shows the hypotheses resulting from the spelling recovery.processing described above.

Next, upon receiving the hypotheses generated through the spelling recovery processing executed by the spelling recovery unit 112, the morpheme segmentation·POS tagging unit 113 prepares candidates each in correspondence to one of the hypotheses by dividing the hypothesis into morphemes and appending POS tags (F203).

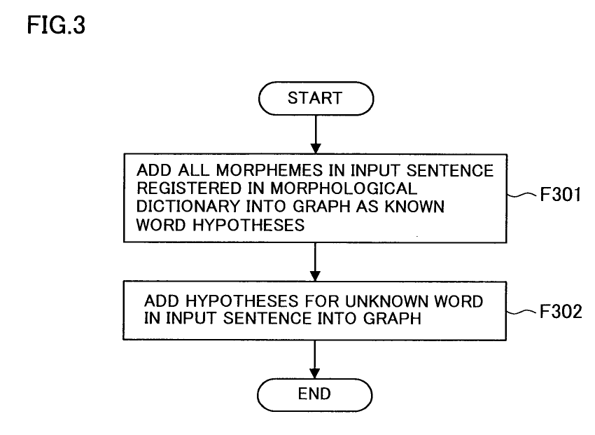

FIG. 3 presents a flowchart of the processing executed by the morpheme segmentation POS tagging unit 113 to prepare hypotheses having undergone the morpheme segmentation and the POS tagging.

As shown in FIG. 3, upon receiving the hypotheses representing recovered spellings from the spelling recovery unit 112, the known word hypothesis generation unit 114 prepares known word hypotheses in correspondence to each of the hypotheses based upon the morphological dictionary stored in the morphological dictionary storage unit 122 (F301). The term “known word” in this context is used to refer to a character sequence contained in the morphological dictionary.

FIG. 7 presents an example of the morphological dictionary stored in the morphological dictionary storage unit 122. The morphological dictionary in FIG. 7 contains a plurality of morpheme/POS pairs with the morpheme and the POS separated by “/”.

Assuming that hypotheses such as those in FIG. 10 have been prepared, the known word hypothesis generation unit 114 generates a morphological hypothesis “ab/X” in correspondence the hypothesis “abf+g/V”, which contains the morpheme “ab/X”.

It also generates a hypothesis of the morpheme “g” coupled with the POS tag “V” (g/V), which has been defined during the spelling recovery processing.

In addition, it generates hypotheses for the morphemes “ab/X” and “cdh/Z” in correspondence to the hypothesis “abcdh” in FIG. 10 and likewise generates hypotheses for the morphemes “ab/X”, “cde/Y” and “de/W” contained in the hypothesis “abcde”.

Next, the unknown word hypothesis generation unit 115 generates unknown word hypotheses in correspondence to the hypotheses representing the recovered spellings (F302). The term “unknown word” used in this context refers to a morpheme that is not contained in the morphological dictionary.

While any of various methods may be adopted to generate unknown word hypotheses, the unknown word processing method disclosed in nonpatent reference literature 3 (“Chinese and Japanese Word Segmentation Using Word-Level and Character-Level Information by Nakagawa, In Proceedings of COLING 2004, pp. 466-472, 2004”) may be a viable option.

Nonpatent reference literature 3 discloses a method for processing an unknown word in units of characters, by, for instance, attaching four different character position tags (a tag for the character present at the beginning of the word, a tag for a character present at a middle position in the word, a tag for the character present at the end of the word and a tag for a character constituting a word by itself) to characters constituting an unknown word.

An explanation is provided in reference to the embodiment by using “U”-tag collectively representing the four different character position tags.

For instance, assuming that the hypotheses such as those shown in FIG. 10 have been provided, hypotheses to undergo the unknown word processing, constituted with the individual characters “a”, “b” and “f”, are generated in correspondence to the hypothesis “abf+g/V”.

In addition, hypotheses to undergo the unknown word processing are generated each in correspondence to one of the characters “a”, “b”, “c”, “d” and “h” contained in the hypothesis “abcdh” in FIG. 10 and likewise, hypotheses to undergo the unknown word processing are generated each in correspondence to one of the characters “a”, “b”, “c”, “d” and “e” contained in the hypothesis “abcde”.

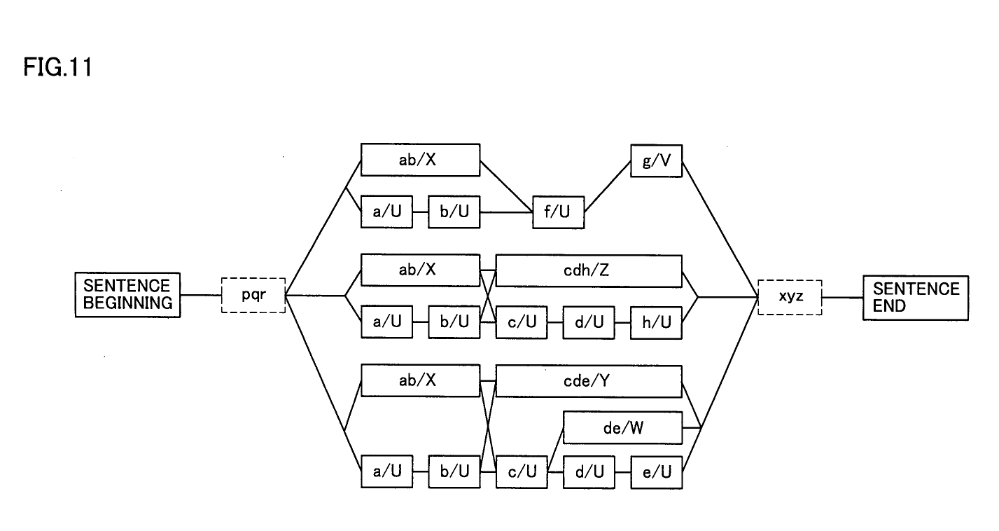

Through the processing described above, hypotheses such as those shown in FIG. 11 are generated.

As described above, the number of hypotheses that need to be generated from a word can be reduced if the word has constraints of morpheme boundaries and POS tags, since extra known word/unknown word candidates do not need to be prepared for the character sequences with constraints .

Next, upon receiving the hypotheses generated by the morpheme segmentation·OS tagging unit 113, the generation probability calculation unit 116 calculates the generation probability for each of the solution candidates, based upon the probabilistic model parameters stored in the probabilistic model parameter storage unit 123 (F204). It is to be noted that each path starting at the node indicating the sentence start and ending at the node indicating the sentence end in FIG. 11 is a solution candidate.

The generation probability for each solution candidate is calculated by adopting the following method. Let us now assume that 1 represents the number of words contained in the input sentence, ωi represents the ith word counting from the beginning of the input sentence, n represents the number of morphemes contained in the input sentence, mi and ti respectively represent the ith morpheme counting from the beginning of the input sentence and the POS tag for the morpheme, word sequence W=ω1 . . . ω1, morpheme sequence M=mi . . . mn and POS sequence T=t1 . . . tn.

Since each hypothesis input to the generation probability calculation unit 116, i.e., the morpheme sequence and the POS sequence corresponding to each solution candidate, can be expressed by using M and T, the hypothesis with the highest generation probability should be selected as the solution.

Accordingly, the morpheme sequence Mˆ and the POS sequence Tˆ corresponding to the correct solution are calculated as expressed below.

The word sequence W′ having undergone the spelling recovery is expressed as W′=ω′1 . . . ω′1, with ω′i representing the ith word the spelling of which has been recovered, counting from the beginning of the input sentence. In addition, it is assumed that the character sequence obtained by concatenating mi is identical to the character sequence obtained by concatenating ωi (m1 . . . mn=ω′1 . . . ω′1).

In expression (1) above, P(M, T|W′) indicates the probability of the morpheme sequence and the POS sequence being generated from the word sequence having undergone the spelling recovery. P(M, T|W′) can be calculated by adopting a method in the related art such as that disclosed in nonpatent reference literature 3, and the probabilistic model parameters based upon which P(M, T|W′) is calculated are stored in the probabilistic model parameter storage unit 123.

In addition, while P(W′|W) indicates the probability of the post-spelling recovery word sequence being generated from the pre-spelling recovery generation word sequence, this probability may be determined by calculating the probability for each word, as indicated in expression (2) below.

P(ω′|ω) can be calculated as in expression (3) below when the spelling of a word ω is recovered to ω′ based upon a spelling recovery rule (r->r′).

P (r->r′|r) in expression (4) above indicates the probability of the spelling recovery rule (r->r′) being applied to the character sequence r, and the value representing this probability is stored in the probabilistic model parameter storage unit 123. In addition, the relationship x<y in this expression is defined to indicate a partial order relation whereby a character sequence x ends a character sequence y (x is a suffix of y) and the relationship x<y is defined to indicate both that x≦y and that x≠y.

The solution search unit 117 selects the solution candidate achieving the highest generation probability for the overall sentence among the solution candidates for which the generation probabilities have been calculated by the generation probability calculation unit 116 (F205). Such a search may be executed based upon the Viterbi algorithm.

The output unit 118 outputs the solution having been determined by the solution search unit 117 to the user (F206).

Next, the operations executed to obtain the dictionary, the parameters and the like to be used in the morphological analysis processing executed in the morphological analysis system 100 in the embodiment are explained in reference to drawings.

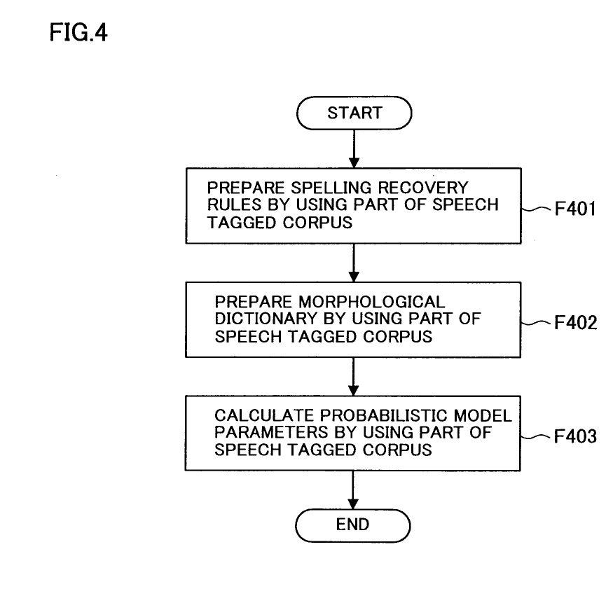

FIG. 4 presents a flowchart of the operation executed to prepare the dictionary and determine the parameters and the like, to be used in the processing executed in the morphological analysis system in the embodiment, based upon a corpus appended with POS tags.

As shown in FIG. 4, the spelling recovery rule preparation unit 132 prepares spelling recovery rules based upon the morphologically analyzed corpus stored in the morphologically analyzed corpus storage unit 131 and stores the spelling recovery rules thus prepared into the spelling recovery rule storage unit 121 (F401).

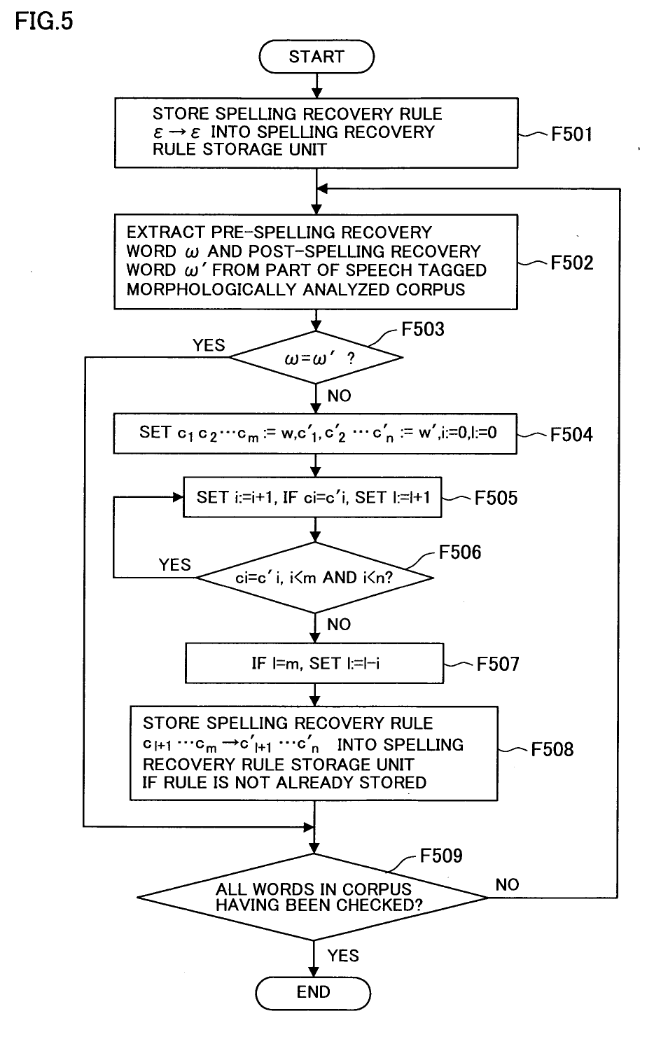

FIG. 5 presents a flowchart of an example of processing that may be executed by the spelling recovery rule preparation unit 132 when preparing spelling recovery rules.

As shown in FIG. 5, the special rule (ε->ε) is first stored into the spelling recovery rule storage unit 121 (F501).

A set of words made up with a pre-spelling recovery word ω and the corresponding post-spelling recovery word ω′, is extracted from the corpus stored in the POS tagged corpus storage unit 131 (F 502).

At this time, a decision is made (F 503) as to whether or not the pre-spelling recovery word ω and the post-spelling recovery word ω′ are identical to each other and, if the word ω and the post-spelling recovery word ω′ are identical, the processing does not require any spelling recovery rules. Accordingly, the operation proceeds to F 509 but if the words are not identical to each other, the operation proceeds to execute the processing in F 504.

If the word ω and the word ω′ are not identical, m is assigned to represent the number of characters in the word W, n is assigned to represent the number of characters in the word W′, cx is assigned to represent the xth character counting from the beginning of the word W and c′x is assigned to represent the xth character counting from the beginning of the word W′. Thus, W=c1 . . . cm and W′=c′1 . . . c′n. In addition, zero is selected as the values of variables i and 1 (F 504).

The variable i indicates the position of the character undergoing the processing with the number of characters counted from the beginning of the word. In addition, the variable 1 indicates the maximum number of common characters included both in the word ω and in the word ω′, counted from the beginning of the words.

First, 1 is added to the value of the variable i and then a decision is made as to whether or not the character ci in the word ω matches the character c′i in the word ω′. If ci=c′i, 1 is added to the value of the variable 1 (F 505).

Then, a decision is made (F 506) as to whether or not ci=c′i, i<m and i<n are all true. If it is decided that ci=c′i, i<m and i<n are all true, the operation returns to step F 505.

If, on the other hand, it is decided that any of ci=c′i, i<m and i<n are not true, the operation proceeds to step F 507.

In F 507, the number of characters m constituting the pre-recovery word ω is compared with the value of the variable 1, and if 1=m, 1 is subtracted from the value of the variable 1 (F 507). By executing this processing, it is ensured that the length of a character sequence that has not undergone the spelling recovery based upon the spelling recovery rules is always equal to or greater than 1.

If a spelling recovery rule c1+1 . . . cm->c′1+1 . . . c′n is not already present in the spelling recovery rule storage unit 121, the rule is added into the spelling recovery rule storage unit 121 (F 508).

When the processing described above has been executed for all the words in the corpus stored in the morphologically analyzed corpus storage unit 131, the procedure ends but otherwise, the operation returns to F 502 to repeatedly execute the processing.

It is to be noted that a post-spelling recovery word can be obtained from the morphologically analyzed corpus by eliminating the morpheme boundary marks and POS tags from the morphemes and the POS tags from the morphologically analyzed word.

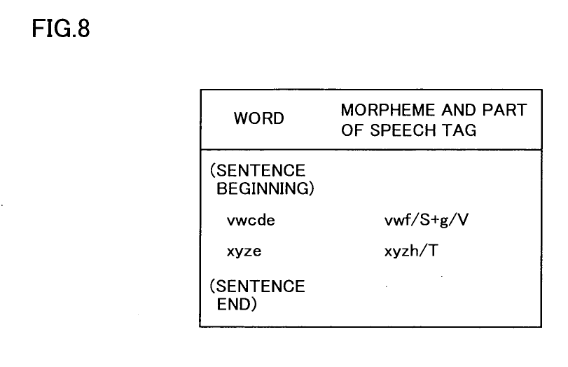

For instance, the morphologically analyzed corpus in FIG. 8 corresponds to a sentence “vwcde xyze” and lists each word and the corresponding morphemes and the POS tags indicated in the analysis results, in the order matching the order with which the individual words appear in the sentence.

A spelling recovery rule is made from the pre-spelling recovery word “vwcde” and the post-spelling recovery word “vwfg” which is obtained from the morphologically analyzed word “vwf/S+g/V”.

If constraints such as morpheme boundary marks and POS tags need to be applied to the recovered character sequence based upon spelling recovery rules, spelling recovery rules with such constraints are prepared through the processing executed in F 508. Under such circumstances, spelling recovery rules such as those shown in FIG. 6 may be prepared from the corpus shown in FIG. 8.

The morphological dictionary preparation unit 133 prepares a morphological dictionary by extracting morphemes and POS tags from the morphologically analyzed corpus stored in the morphologically analyzed corpus storage unit 131 and stores the morphological dictionary thus prepared into the morphological dictionary storage unit 122 (F 402).

The probabilistic model parameter calculation unit 134 calculates probabilistic model parameters based upon the morphologically analyzed corpus stored in the morphologically analyzed corpus storage unit 131 and stores the probabilistic model parameters thus calculated into the probabilistic model parameter storage unit 123 (F 403).

As explained above, since P(M, T|W′) in expression (1) can be calculated by adopting a method in the related art, the probabilistic model parameters to be used to calculate P(M, T|W′), too, can also be determined in a similar manner by adopting a known method. In addition, P(r->r′|r), a parameter needed in the calculation expressed in (4) should be determined as indicated below.

The symbol “<” in the expression above has the same meaning as that of the symbol in expression (4) and f(x->x′|y) indicates the number of times a word that contains the character sequence y as its suffix, to which the spelling recovery rule x->x′ is applied appears in the corpus stored in the POS tagged corpus storage unit 131. The value representing the number of times the word appears in the corpus can be determined through a procedure similar to that shown in FIG. 5.

(A-3) Advantages of the First Embodiment

Even when a word in a sentence input in the Korean language contains altered word forms through contraction or the like, the words can be morphologically analyzed. An input sentence can be robustly analyzed even if it contains unknown words, since the spelling recovery processing is conducted first and then hypotheses for the unknown word are generated. By executing an arithmetic operation as expressed in (1), the most probable morpheme sequence and POS sequence for the input sentence can be determined through the overall morphological analysis processing. The dictionary and the parameters to be used in the morphological analysis can all be prepared by using the morphologically analyzed corpus, without requiring any human expertise.

### (B) Other Embodiments

In the morphological analysis apparatus according to the present invention, an input sentence having been entered first undergoes the spelling recovery processing so as to recover the altered spellings of morphemes resulting from contraction or the like. Then, the morpheme boundary points and the corresponding POS categories are identified. By executing both the spelling recovery processing and the morpheme segmentation POS tagging processing through an integrated procedure based upon probabilistic models, the optimal solution can be selected as a result of the overall morphological analysis processing. The dictionary, the parameters and the like needed in the morphological analysis can be obtained automatically based upon training data. In addition, morphological analysis of unknown words is possible as well as that of known words.

As long as the analysis unit 110, the model storage unit 120 and the model learning unit 130 in the morphological analysis system 100 in FIG. 1 are capable of operating in coordination with one another, they may be installed at separate locations on, for instance, a network and in such a case, each unit may execute its processing away from the others.

While an explanation is given above in reference to the embodiment on an example in which sentences are entered in the Korean language, the present invention may be adopted in conjunction with Japanese or any other language simply by using an appropriate corpus.

What is claimed is;

1. A morphological analysis apparatus, comprising:
a spelling recovery unit that converts the spelling of a word in an input sentence based upon a specific spelling recovery rule;
a morphological analysis candidate generation unit that segments a word sequence composed of words, the spellings of which have been recovered by the spelling recovery unit into morphemes, appends a “part of speech” tag to each of the morphemes and generates a single and morphological analysis candidate or a plurality of morphological analysis candidates;
a generation probability calculation unit that calculates a generation probability for each morphological analysis candidate having been generated based upon the product of the probability of the pre-spelling recovery word being converted to the post-spelling recovery word and the probability of a morpheme sequence and a part of speech sequence being generated from the post-spelling recovery word sequence; and
a solution search unit that selects through a search the most likely candidate as a solution from the morphological analysis candidates for which the generation probabilities have been calculated by the generation probability calculation unit.

2. A morphological analysis apparatus, according to claim 1, further comprising:
a morphologically analyzed corpus storage unit in which a plurality of sets of word information related to a plurality of morphologically analyzed words are stored; and
a spelling recovery rule preparation unit that prepares the spelling recovery rule based upon a pre-spelling recovery word and a corresponding post-spelling recovery word stored in the corpus storage unit.

3. A morphological analysis apparatus, according to claim 2, wherein:
the spelling recovery rule preparation unit is capable of preparing a spelling recovery rule that applies constraints with morpheme boundary marks and part of speech tags to a post-spelling recovery character sequence.

4. A morphological analysis apparatus, according to claim 1, wherein:
the generation probability calculation unit calculates the probability of the pre-spelling recovery word being converted to the post-spelling recovery word based upon an application rate of the spelling recovery rule at which the spelling recovery rule has been adopted in spelling recovery processing executed by the spelling recovery unit on the word in the input sentence.

5. A morphological analysis apparatus, according to claim 4, further comprising:
a morphologically analyzed corpus storage unit in which a plurality of sets of word information related to a plurality of morphologically analyzed words are stored; and
a spelling recovery rule preparation unit that prepares the spelling recovery rule based upon a pre-spelling recovery word and a corresponding post-spelling recovery word stored in the corpus storage unit.

6. A morphological analysis apparatus, according to claim 5, wherein:
the spelling recovery rule preparation unit is capable of preparing a spelling recovery rule that applies constraints with morpheme boundary marks and part of speech tags to a post-spelling recovery character sequence.

7. A morphological analysis method comprising:
a spelling recovery step in which the spelling of a word in an input sentence is converted based upon a specific spelling recovery rule;
a morphological analysis candidate generation step in which a word sequence containing words with the spellings thereof having been recovered through the spelling recovery step, is segmented into morphemes, “part of speech” tags are attached to the morphemes and a single morphological analysis candidate or a plurality of morphological analysis candidates are generated;
a generation probability calculation step in which a generation probability is calculated for each morphological analysis candidate having been generated, based upon the product of a probability of the pre-spelling recovery word being converted to the post-spelling recovery word and a probability of a morpheme sequence and part of speech sequence being generated from the post-spelling recovery word sequence; and
a solution search step in which the most likely candidate is selected through a search as a solution from the morphological analysis candidates for which the generation probabilities have been calculated through the generation probability calculation step.

8. A morphological analysis method according to claim 7, wherein:
the spelling recovery rule is prepared through
a morphologically analyzed corpus storage step in which a plurality of sets of word information related to a plurality of morphologically analyzed words are stored; and
a spelling recovery rule preparation step in which the spelling recovery rule is prepared based upon a pre-spelling recovery word and a corresponding post-spelling recovery word stored through the corpus storage step.

9. A morphological analysis method according to claim 8, wherein:
in the spelling recovery rule preparation step, a spelling recovery rule that applies constraints with morpheme boundary marks and part of speech tags to a post-spelling recovery character sequence can be prepared.

10. A morphological analysis method according to claim 7, wherein:
in the generation probability calculation step, the probability of the pre-spelling recovery word being converted to the post-spelling recovery word is calculated based upon an application rate of the spelling recovery rule at which the spelling recovery rule has been adopted in spelling recovery processing executed in the spelling recovery step on the word in the input sentence.

11. A morphological analysis method according to claim 10, wherein:
the spelling recovery rule is prepared through
a morphologically analyzed corpus storage step in which a plurality of sets of word information related to a plurality of morphologically analyzed words are stored; and
a spelling recovery rule preparation step in which the spelling recovery rule is prepared based upon a pre-spelling recovery word and a corresponding post-spelling recovery word stored through the corpus storage step.

12. A morphological analysis method according to claim 11, wherein:
in the spelling recovery rule preparation step, a spelling recovery rule that applies constraints with morpheme boundary marks and part of speech tags to a post-spelling recovery character sequence can be prepared.

13. A morphological analysis program that enables a computer to function as:
a spelling recovery unit that converts the spelling of a word in an input sentence based upon a specific spelling recovery rule;
a morphological analysis candidate generation unit that segments a word sequence composed of words, the spellings of which have been recovered by the spelling recovery unit into morphemes, appends a “part of speech” tag to each of the morphemes and generates a single and morphological analysis candidate or a plurality of morphological analysis candidates;
a generation probability calculation unit that calculates a generation probability for each morphological analysis candidate having been generated based upon the product of the probability of the pre-spelling recovery word being converted to the post-spelling recovery word and the probability of a morpheme sequence and a part of speech sequence being generated from the post-spelling recovery word sequence; and
a solution search unit that selects through a search the most likely candidate as a solution from the morphological analysis candidates for which the generation probabilities have been calculated by the generation probability calculation unit.

14. A morphological analysis program according to claim 13, that enables the computer to further function as:
a morphologically analyzed corpus storage unit in which a plurality of sets of word information related to a plurality of morphologically analyzed words are stored; and
a spelling recovery rule preparation unit that prepares the spelling recovery rule based upon a pre-spelling recovery word and a corresponding post-spelling recovery word stored in the corpus storage unit.

15. A morphological analysis program according to claim 14, wherein:
the spelling recovery rule preparation unit is capable of preparing a spelling recovery rule that applies constraints with morpheme boundary marks and part of speech tags to a post-spelling recovery character sequence.

16. A morphological analysis program according to claim 13, wherein:
the generation probability calculation unit calculates the probability of the pre-spelling recovery word being converted to the post-spelling recovery word based upon an application rate of the spelling recovery rule at which the spelling recovery rule has been adopted in spelling recovery processing executed by the spelling recovery unit on the word in the input sentence.

17. A morphological analysis program according to claim 16, that enables the computer to further function as:
a morphologically analyzed corpus storage unit in which a plurality of sets of word information related to a plurality of morphologically analyzed words are stored; and
a spelling recovery rule preparation unit that prepares the spelling recovery rule based upon a pre-spelling recovery word and a corresponding post-spelling recovery word stored in the corpus storage unit.

18. A morphological analysis program according to claim 17, wherein:
the spelling recovery rule preparation unit is capable of preparing a spelling recovery rule that applies constraints with morpheme boundary marks and part of speech tags to a post-spelling recovery character sequence.
